(19) United States
(12) Patent Application Publication
(10) Pub. No.: US 2026/0171697 A1
(43) Pub. Date: Jun. 18, 2026

(54) POWER CONNECTOR DEVICE FOR STABLE POWER SUPPLY

(71) Applicant: Aivres Systems Inc., San Jose, CA (US)

(72) Inventor: Wen-Chi SHEN, New Taipei City (TW)

(21) Appl. No.: 18/986,318

(22) Filed: Dec. 18, 2024

(51) Int. Cl. H01R 12/70; H01R 12/71

(52) U.S. Cl. CPC H01R 12/7088; H01R 12/7047; H01R 12/7052; H01R 12/707; H01R 12/716

(57) ABSTRACT

One or more embodiments of the present specification provide stable power supply methods, apparatuses, and systems. A power connector device includes a male component soldered to a first printed circuit board (PCB), and a female component soldered to a second PCB. The first PCB connects to a power supply and the second PCB connects to a server node. The male component includes two or more alignment pins that plug into the first PCB to align the male component in a first predetermined orientation for proper coupling with the female component. The female component includes two or more alignment pins that plug into the second PCB to align the female component in a second predetermined orientation for proper coupling with the male component. The server node receives a power that is higher than a threshold from the power supply when the male component and the female component are properly coupled.

### BACKGROUND

With the development and the widespread application of cloud computing, the amount of data communicated through networks and processed by servers is increasing. This increases data storage and processing requirements of data centers that host the servers. To meet increasing demands of services, data centers use high-density servers that allows multiple compute nodes in a single chassis, which can efficiently use available physical space in data center rooms. By deploying high-density servers in the data centers, capacity and power requirements of data servers can significantly increase within existing data center room environments.

When an amount of services increases, load current on a motherboard of a high-density server can increase. To accommodate conduction of a higher load current, a power connector on the motherboard needs to have a large size. However, the power connector can take up too much space on a printed circuit board (PCB) of the motherboard. As a result, air flow can be blocked and may affect cooling of the motherboard of the server node inside a server chassis. Traditional power blade power connectors can have large physical sizes. When conducting increasingly high currents, the sizes of the power blade power connectors are restricted by the limited size of the server chassis structure. Thus, traditional power blade power connectors are not suitable for high-density servers that have limited physical space.

### SUMMARY

The present disclosure describes a power connector device for providing a stable power supply to high-density servers. In particular, a power connector can include alignment pins and screws in its male component and female component. When the male and female components are assembled, the male component and the female component of the power connector can be properly coupled, providing stable power supply to server nodes of high-density servers.

In an implementation, a power connector device includes a male component soldered to a first printed circuit board (PCB), and a female component soldered to a second PCB. The first PCB connects to a power supply and the second PCB connects to a server node, or the second PCB connects to a power supply and the first PCB connects to a server node. The male component includes two or more alignment pins that plug into the first PCB to align the male component in a first predetermined orientation for proper coupling with the female component. The female component includes two or more alignment pins that plug into the second PCB to align the female component in a second predetermined orientation for proper coupling with the male component. The server node receives a power that is higher than a threshold from the power supply when the male component and the female component are properly coupled.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. A power connector having alignment pins and screws in its male component and female component can ensure that the male component and the female component of the power connector are properly aligned and coupled, providing a stable power supply to server nodes of high-density servers. The described power connector can support different types of high-density servers and storage systems. The guide rails of the described power guide power connector can be soldered at precise locations on a printed circuit board (PCB), preventing location and orientation inaccuracies during the soldering process and improving a percentage of manufactured products that satisfy a product inspection criterion. The described systems and techniques can ensure that server nodes can be plugged and unplugged smoothly while the power of a server stays on or while performing a hot maintenance of the server. The described systems and techniques can reduce the design and manufacturing cost of the power connectors in high-density servers.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is a block diagram of a power connector device, including alignment pins and screws with respect to a male component and a female component for proper alignment and coupling, according to an implementation of the present disclosure.

FIG. 1B is a side view of a non-coupling side of a female component, according to an implementation of the present disclosure.

FIG. 1C is a side view of a non-coupling side of a male component, according to an implementation of the present disclosure.

FIG. 2A is an image of a side view of a power board assembly that includes a power connector device, according to an implementation of the present disclosure.

FIG. 2B is an image of the bottom of the power board assembly in FIG. 2A that includes a power connector device, according to an implementation of the present disclosure.

FIG. 3A is a perspective view of an image of a male pin of a male component of a power connector device, according to an implementation of the present disclosure.

FIG. 3B is a bottom view of an image of a male pin of a male component of a power connector device, according to an implementation of the present disclosure.

FIG. 3C is a perspective view of an image of a socket of a female component of the power connector device, according to an implementation of the present disclosure.

FIG. 3D is a bottom view of an image of a socket of a female component of the power connector device, according to an implementation of the present disclosure.

Like reference numbers and designations in the various drawings indicate like elements.

### DETAILED DESCRIPTION

The following detailed description describes a power connector device for providing a stable power supply to high-density servers and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

In high-density server applications, multiple independent server nodes are housed within a single physical chassis of a high-density server. A server node typically needs to support hot-plug operations, such as adding or removing the server node without powering off a high-density server. To support the hot-plug operations, a guidepost for structural positioning of the server node is installed on the server node.

A power guide power connector has one or more guideposts for structural positioning and can conduct high load current. The power guide power connector is connected to a PCB by a soldering process. However, during the soldering process, it can be difficult to align the power guide power connector at a desired location and orientation on the PCB because it can be challenging to keep the soldering firm and flat. As a result, when assembling a server node of a high-density server, because of the misalignment of the power guide power connector, the power connector of the server node may not be properly coupled and the power supply through the power connector may not be stable. For example, when a user is plugging in or is removing the server node, it can be difficult to connect or disconnect the power guide power connector of the server node because of the misalignment of the power guide power connector.

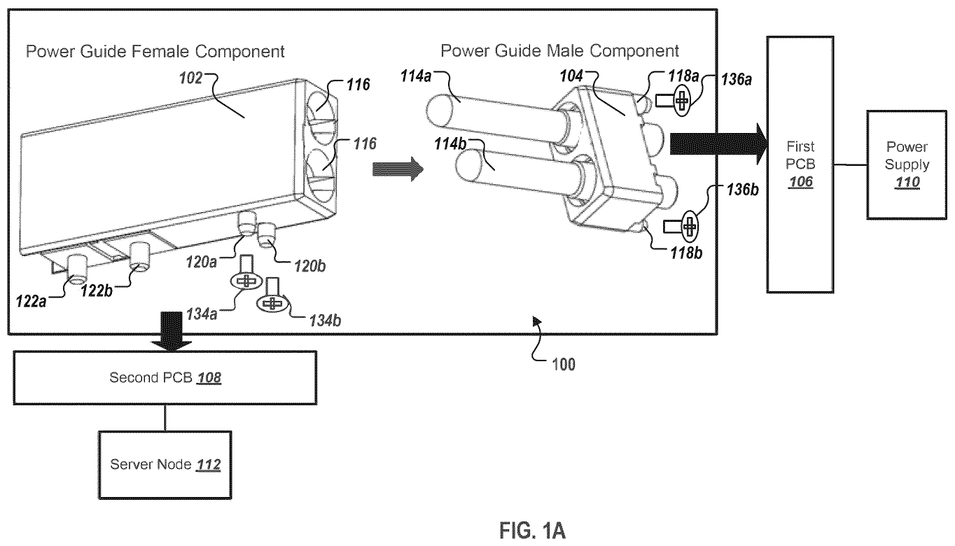

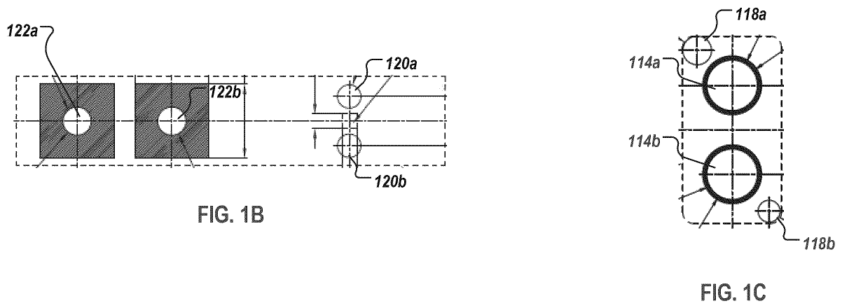

FIG. 1A is a block diagram of a power connector device 100, including alignment pins and screws with respect to a male component and a female component for proper alignment and coupling, according to an implementation of the present disclosure. The power connector device 100 is a power guide power connector. The power connector device 100 includes a male component 104 and a female component 102. The male component 104 includes two male pins 114 (shown as 114a and 114b in FIG. 1). The male pins 114 are cylindrical guideposts that can conduct high currents. The female component 102 includes two sockets 116 that match the cylindrical guideposts of the male pins 114.

The male component 104 is soldered to a first printed circuit board (PCB) 106. For example, the coupling side of the male pins 114 plugs into the sockets 116 of the female component 102, the non-coupling side of the male pins 114 is soldered to the first PCB 106. The first PCB 106 can be configured to have holes corresponding to the diameters of the non-coupling side of the male pins 114. In some implementations, the two male pins 114 can have different diameters, to prevent the male component 104 from being installed incorrectly on the first PCB 106. For example, the diameter of the male pin 114a can be larger than the diameter of the male pin 114b by a predetermined threshold, such as 25%, 30%, or 35%. The holes on the first PCB 106 can have a corresponding size difference to prevent the male component 104 being soldered upside down on the first PCB 106.

The female component 102 is soldered to a second PCB 108. For example, the female component 102 can include two alignment pins 122 (shown as 122a and 122b in FIG. 1) that are soldered to the second PCB 108. The second PCB 108 can be configured to have holes corresponding to the diameters of the alignment pins.

One of the two PCBs 106 and 108 is connected to a power supply and the other of the two PCBs 106 and 108 is connected to a server node. Thus, the power supply can provide power to the server node through the power connector device 100. For example, as illustrated in FIG. 1, the first PCB 106 that the male component 104 is soldered on is connected to a power supply 110, and the second PCB 108 that the female component 102 is soldered on is connected to a server node 112. In some implementations, the first PCB 106 that the male component 104 is soldered on can be connected to a server node, and the second PCB 108 that the female component 102 is soldered on can be connected to a power supply. The power connector device 100 can provide power from the power supply 110 to the server node 112 when the male component 104 and the female component 102 are coupled together.

During the soldering process, it can be difficult to align the power connector at a desired location and orientation on the PCBs because it can be challenging to keep the soldering firm and flat. Some reasons for the imperfect soldering can include difficulty controlling an amount of solder paste applied, difficulty controlling temperature during the soldering process, or a combination of both. For example, because of the heavy weight of the male pins of the male component, the male component may not be soldered at a desired location and a desired orientation on the PCB due to insufficient flatness of the soldering process. Similarly, the female component may not be soldered at a desired location and a desired orientation on the other PCB. As a result, because of possible misalignment of the male component and the female component, the male component and the female component may not properly couple. Thus, the power supply through these power connectors to server nodes may not be stable.

The power connector device 100 described in this specification includes two or more alignment pins, two or more screws, or a combination of both, in its male component 104 and female component 102. By having the alignment pins, the screws, or both, the power connector device 100 can ensure that the male component 104 and the female component 102 of the power connector device 100 are properly coupled, providing stable power supply to server nodes 112 of high-density servers.

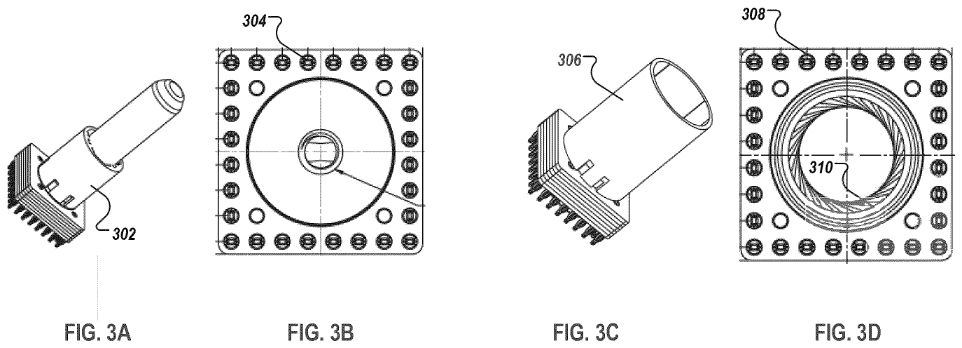

The male component 104 includes two or more alignment pins (such as 118a and 118b in FIG. 1) that plug into (e.g., soldered on) the first PCB 106 to align the male component 104 in a predetermined orientation for proper coupling with the female component 102. The female component 102 includes two or more alignment pins 120 (shown as 120a and 120b in FIG. 1) that plug into (e.g., soldered on) the second PCB 108 to align the female component 102 in a predetermined orientation for proper coupling with the male component 104. In some implementations, the female component 102 can include a pair of alignment pins 120a and 120b that are perpendicular to another pair of alignment pins 122a and 122b. In some implementations, two or more alignment pins of the male component and/or the female component can be located at predetermined locations and can be arranged with a predetermined shape. Additional examples of the alignment pins are described below in connection with FIGS. 3A-3D.

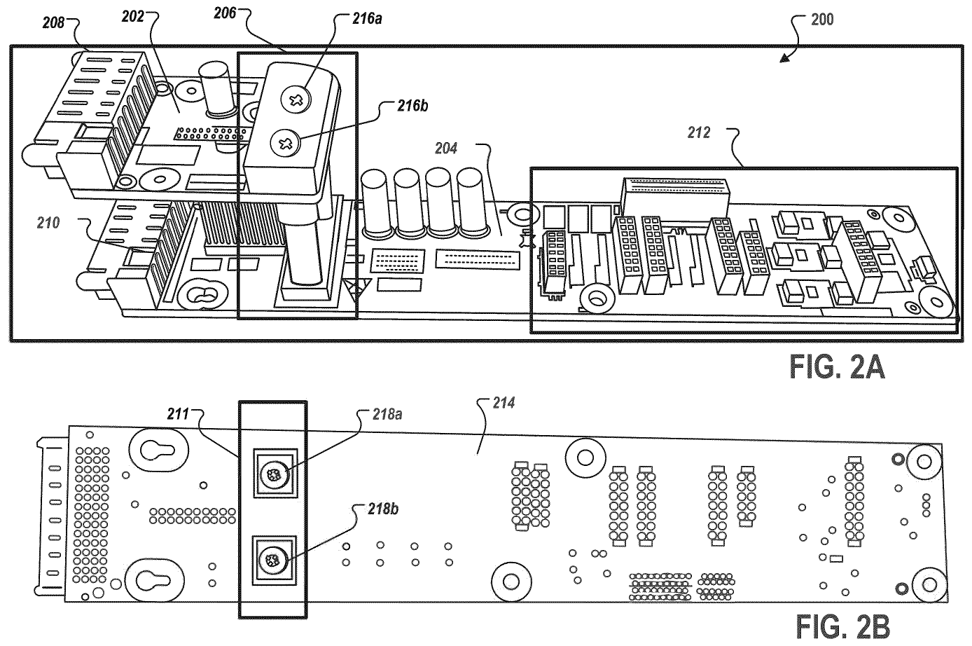

The server node 112 can receive power that is higher than a threshold from the power supply 110 when the male component 104 and the female component 102 are properly coupled. In some implementations, the male component 104 and the female component 102 are properly coupled when they satisfy a coupling criterion. The coupling criterion can include a coupling angle that satisfies an angular threshold, a contact area that is larger than a threshold, a combination of both, or other appropriate criteria. For example, the coupling criterion for the male and the female components can include a connection at a right angle of a ninety-degrees. The coupling criterion for the male and the female components can include that the contact area between the male and the female components satisfies a predetermined threshold. Additional coupling criteria are described below in connection with FIGS. 2A-2B.

In some implementations, at least one alignment pin of the two or more alignment pins of the male component or the female component can be configured with a hole to permit a screw to attach the male component or the female component to the corresponding PCB. The screw can improve flatness and firmness of the soldering process and ensure that the corresponding male component, or the corresponding female component is at the predetermined orientation for proper coupling.

For example, each of the alignment pins 118a and 118b of the male component 104 can be configured with a hole. After attaching the male component 104 to one side of the first PCB 106, two screws 136a and 136b can be screwed into the alignment pins 118 of the male component 104 from the other side of the first PCB 106. Each of the alignment pins 120a and 120b of the female component 102 can be configured with a hole. After attaching the female component 102 to one side of the second PCB 108, two screws 134a and 134b can be screwed into the alignment pins 120 of the female component 102 from the other side of the second PCB 108.

In some implementations, the screw can be electrically conductive and can be used to vary a resistance of the power connector device 100 for controlling an amount of the power received by the server node. The screw can provide a preset amount of resistance based on a configuration of the screw. For example, the screws 136 can be made of an electrically conductive material, such as aluminum or iron, and the alignment pins 118 can be connected to the male pins 114 that conduct power to the server node 112. The screws 136 can provide a preset amount of resistance based on a configuration of the screw 136s, such as the size, the shape, and the material of the screws 136. The screws 136 can be used to vary a resistance of the male component 104 for controlling an amount of power that can be conducted through the power connector device 100 to the server node 112. Similarly, the screws 134 of the female component 102 can be electrically conductive and can be used to vary a resistance of the female component 102 for controlling an amount of the power received by the server node 112.

In some implementations, the two or more alignment pins of the male component or the female component can be at two diagonal corners of a perimeter of the male component or the female component. FIG. 1C is a side view of the non-coupling side of the male component 104. FIG. 1C shows the non-coupling side of the male pins 114a and 114b. The two alignment pins 118a and 118b are at two diagonal corners of the male component 104.

In some implementations, one alignment pin of the two or more alignment pins of the male component can be larger than another alignment pin of the two or more alignment pins of the male component to ensure that the male component is oriented on the first PCB correctly. For example, as shown in FIG. 1C of a side view of the non-coupling side of the male component 104, the alignment pin 118a of the male component 104 can be larger than the alignment pin 118b of the male component 104 to ensure that the male component 104 is oriented on the first PCB 106 correctly. For example, the diameter of the alignment pin 118a can be larger than the diameter of the alignment pin 118b by a threshold, such as 20%, 30%, or 35%.

In some implementations, one alignment pin of the two or more alignment pins of the female component can be larger than another alignment pin of the two or more alignment pins of the female component to ensure that the female component is oriented on the second PCB correctly. FIG. 1B is a side view of the non-coupling side of the female component 102. For example, the female component 102 has four alignment pins 122a, 122b, 120a, and 120b. The alignment pins 122a and 122b (having the same size) can be larger than the alignment pins 120a and 120b (having the same size) to ensure that the female component 102 is oriented on the second PCB 108 correctly. For example, the diameter of the alignment pins 122a and 122b can be larger than the diameter of the alignment pins 120a and 120b by a threshold, such as 20%, 30%, or 35%.

In some implementations, the server node 112 can be one of multiple nodes included in a server, wherein the power connector device 100 can be used to add or remove the server node 112 in the server without powering off the server. For example, the server node 112 can be a node in a high-density server. The power connector device 100 can be used to add the server node 112 in the server during a hot-plug operation or during a hot maintenance operation.

FIG. 2A is an image of a side view of a power board assembly 200 that includes a power connector device 206, according to an implementation of the present disclosure. The power connector device 206 is a power guide power connector that includes a male component and a female component that are properly coupled with each other. The power board assembly 200 includes a first PCB 204 and a second PCB 202. The male component of the power connector device 206 is soldered on the first PCB 204. The female component of the power connector device 206 is soldered on the second PCB 202. The first PCB 204 includes multiple sockets 212 that can be used to connect to a server node. FIG. 2B is an image of a bottom of the power board assembly 200 in FIG. 2A that includes the power connector device 206, according to an implementation of the present disclosure. A bottom view of the male component is shown in 211.

The first PCB 204 includes a power connector 210 that can be connected to a first power supply box. The second PCB 202 includes a power connector 208 that can be connected to a second power supply box. Once the first power supply box and the second power supply box are connected to the power supply, e.g., electricity, the power board assembly 200 can provide a sufficient amount of power to at least two server nodes of a motherboard system. By using a more stable power guide power connector, the power board assembly 200 can achieve high quality and efficient power delivery to server nodes with greater stability.

In some implementations, the coupling criterion for the male and the female components can include that the total height of the first power supply box and the second power supply box is substantially the same as the sum of the height of the first power supply box and the height of the second power supply box. For example, when the male and the female components are properly coupled, the first power supply box and the second power supply box should closely contact each other. If each of the first and the second power supply boxes has a same height of four centimeters, the coupling criterion for the male and the female components can include that the total height of the first power supply and the second power supply is substantially the same as eight centimeters, which is the sum of the height of the first power supply and the height of the second power supply.

In some implementations, the male component can include two male pins. The male component can be soldered to one side of the first PCB 204 (the side shown in FIG. 2A) and two screws can lock the male component in the predetermined orientation by connecting the two screws to a non-coupling side of the two male pins from an opposite side (the side 214 shown in FIG. 2B) of the first PCB 106.

For example, after soldering the non-coupling side of the male component to one side of the first PCB 204, two screws 218a and 218b can be screwed into the non-coupling side of the male pins from the other side 214 of the first PCB to further ensure that the male component is locked in the predetermined orientation.

In some implementations, the two screws 218a and 218b that are screwed in the non-coupling side of the male pins can be electrically conductive and can be used to vary a resistance of the power connector device 206 for controlling an amount of the power received by the server node, and the two screws 218 can provide a preset amount of resistance based on a configuration of the two screws.

In some implementations, the female component can include two sockets. The female component can be soldered to one side of the second PCB 202 and two screws 216a and 216b can lock the female component in a predetermined orientation by connecting the two screws 216 to a non-coupling side of the two sockets from an opposite side of the second PCB 202. In some implementations, the two screws 216a and 216b that are screwed in the non-coupling side of the female pins can be electrically conductive and can be used to vary a resistance of the power connector device for controlling an amount of the power received by the server node. The two screws 216a and 216b can provide a preset amount of resistance based on a configuration of the two screws 216.

The various implementations described in connection with FIG. 2A and FIG. 2B are applicable to other configurations of the power connector device, including the power connector device 100 in FIG. 1.

FIG. 3A is a perspective view of an image of a male pin 302 of a male component of the power connector device, according to an implementation of the present disclosure. FIG. 3B is a bottom view of an image of the male pin 302 of the male component of the power connector device, according to an implementation of the present disclosure. The non-coupling side of male pin 302 can include multiple alignment pins 304 surrounding the perimeter of the non-coupling side of the male pin. For example, the non-coupling side of male pin 302 can include 28 alignment pins 304 arranged in a square shape (shown in FIG. 3B), a circle, or other appropriate shapes.

FIG. 3C is a perspective view of an image of a socket 306 of a female component of the power connector device, according to an implementation of the present disclosure. FIG. 3D is a bottom view of an image of the socket 306 of the female component of the power connector device, according to an implementation of the present disclosure. The non-coupling side of socket 306 can include multiple alignment pins 308 surrounding the perimeter of the socket 306. For example, the non-coupling side of socket 306 can include 28 alignment pins 308 arranged in a square shape (shown in FIG. 3D), a circle, or other appropriate shapes.

In some implementations, the socket 306 of the female component of the power connector device can have threaded interior 310. The internal threading of the socket of the female component can provide one or more advantages. The internal threading of the socket of the female component can enhance the stability of connection between the male component and the female component. For example, the threaded interior can ensure that the male and the female components are securely fastened for property coupling, reducing the likelihood of loose connections or accidental disconnections, even in high-vibration environments or with frequent plugins. The internal threading of the socket of the female component can increase durability of the power connector. For example, the internal threading can provide a larger contact area than an unthreaded interior of a female socket, and thus can distribute stress more evenly during the insertion and removal process, and can reduce wear on the internal structure of the female socket, extending the lifespan of the power connector. The internal threading of the socket of the female component can ensure precise alignment. For example, the combination of threaded interior and alignment pins can help ensure precise alignment between the male and the female components during insertion, minimizing the risk of damage caused by incorrect operation. The internal threading of the socket of the female component can improve power transmission efficiency. For example, the internal threading of the female socket can provide a more stable mechanical coupling that reduces contact resistance, thereby decreasing energy loss and improving the efficiency and stability of power delivery. The internal threading of the socket of the female component can support high-power transmission applications. For example, the internal threading design can enable the power connector to handle higher current and power loads, making the power connector particularly suitable for high-density servers or data centers that demand stable power supply.

Described implementations of the subject matter can include one or more features, alone or in combination.

For example, in a first implementation, a power connector device includes a male component soldered to a first printed circuit board (PCB), and a female component soldered to a second PCB. The first PCB connects to a power supply and the second PCB connects to a server node, or the second PCB connects to a power supply and the first PCB connects to a server node. The male component includes two or more alignment pins that plug into the first PCB to align the male component in a first predetermined orientation for proper coupling with the female component. The female component includes two or more alignment pins that plug into the second PCB to align the female component in a second predetermined orientation for proper coupling with the male component. The server node receives a power that is higher than a threshold from the power supply when the male component and the female component are properly coupled.

The foregoing and other described implementations can each, optionally, include one or more of the following features:

A first feature, combinable with any of the following features, wherein at least one alignment pin of the two or more alignment pins of the male component or the female component is configured with a hole to permit a screw to attach the male component or the female component to the corresponding PCB.

A second feature, combinable with any of the previous or following features, wherein the screw is electrically conductive and is used to vary a resistance of the power connector device for controlling an amount of the power received by the server node, wherein the screw provides a preset amount of resistance based on a configuration of the screw.

A third feature, combinable with any of the previous or following features, wherein the male component comprises two male pins, the male component is soldered to one side of the first PCB and two screws lock the male component in the first predetermined orientation by connecting the two screws to a non-coupling side of the two male pins from an opposite side of the first PCB.

A fourth feature, combinable with any of the previous or following features, wherein the two screws are electrically conductive and are used to vary a resistance of the power connector device for controlling an amount of the power received by the server node, wherein the two screws provide a preset amount of resistance based on a configuration of the two screws.

A fifth feature, combinable with any of the previous or following features, wherein the female component comprises two sockets, the female component is soldered to one side of the second PCB and two screws locks the female component in the second predetermined orientation by connecting the two screws to a non-coupling side of the two sockets from an opposite side of the second PCB.

A sixth feature, combinable with any of the previous or following features, wherein the two screws are electrically conductive and are used to vary a resistance of the power connector device for controlling an amount of the power received by the server node, wherein the two screws provide a preset amount of resistance based on a configuration of the two screws.

A seventh feature, combinable with any of the previous or following features, wherein the two or more alignment pins are at two diagonal corners of a perimeter of the male component or the female component.

An eighth feature, combinable with any of the previous or following features, wherein the server node is one of multiple nodes comprised in a server, wherein the power connector device is used to add or remove the server node in the server without powering off the server.

A ninth feature, combinable with any of the previous or following features, wherein the male component and the female component are properly coupled satisfying a coupling criterion.

A tenth feature, combinable with any of the previous or following features, wherein the coupling criterion comprises a coupling angle that satisfies an angular threshold.

An eleventh feature, combinable with any of the previous or following features, wherein the coupling criterion comprises a contact area between the male and the female components that satisfies a predetermined threshold.

A twelfth feature, combinable with any of the previous or following features, wherein one alignment pin of the two or more alignment pins of the male component is larger than another alignment pin of the two or more alignment pins of the male component to ensure that the male component is oriented on the first PCB correctly.

A thirteenth feature, combinable with any of the previous or following features, wherein one alignment pin of the two or more alignment pins of the female component is larger than another alignment pin of the two or more alignment pins of the female component to ensure that the female component is oriented on the second PCB correctly.

A fourteenth feature, combinable with any of the previous or following features, wherein the female component comprises two sockets with threaded interior.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A power connector device, comprising:
a male component soldered to a first printed circuit board (PCB), and
a female component soldered to a second PCB, and
wherein the first PCB connects to a power supply and the second PCB connects to a server node, or the second PCB connects to a power supply and the first PCB connects to a server node,
wherein the male component comprises two or more alignment pins that plug into the first PCB to align the male component in a first predetermined orientation for proper coupling with the female component,
wherein the female component comprises two or more alignment pins that plug into the second PCB to align the female component in a second predetermined orientation for proper coupling with the male component, and
wherein the server node receives a power that is higher than a threshold from the power supply when the male component and the female component are properly coupled.

2. The power connector device of claim 1, wherein at least one alignment pin of the two or more alignment pins of the male component or the female component is configured with a hole to permit a screw to attach the male component or the female component to the corresponding PCB.

3. The power connector device of claim 2, wherein the screw is electrically conductive and is used to vary a resistance of the power connector device for controlling an amount of the power received by the server node, wherein the screw provides a preset amount of resistance based on a configuration of the screw.

4. The power connector device of claim 1, wherein the male component comprises two male pins, the male component is soldered to one side of the first PCB and two screws lock the male component in the first predetermined orientation by connecting the two screws to a non-coupling side of the two male pins from an opposite side of the first PCB.

5. The power connector device of claim 4, wherein the two screws are electrically conductive and are used to vary a resistance of the power connector device for controlling an amount of the power received by the server node, wherein the two screws provide a preset amount of resistance based on a configuration of the two screws.

6. The power connector device of claim 1, wherein the female component comprises two sockets, the female component is soldered to one side of the second PCB and two screws locks the female component in the second predetermined orientation by connecting the two screws to a non-coupling side of the two sockets from an opposite side of the second PCB.

7. The power connector device of claim 6, wherein the two screws are electrically conductive and are used to vary a resistance of the power connector device for controlling an amount of the power received by the server node, wherein the two screws provide a preset amount of resistance based on a configuration of the two screws.

8. The power connector device of claim 1, wherein the two or more alignment pins are at two diagonal corners of a perimeter of the male component or the female component.

9. The power connector device of claim 1, wherein the server node is one of multiple nodes comprised in a server, wherein the power connector device is used to add or remove the server node in the server without powering off the server.

10. The power connector device of claim 1, wherein the male component and the female component are properly coupled satisfying a coupling criterion.

11. The power connector device of claim 10, wherein the coupling criterion comprises a coupling angle that satisfies an angular threshold.

12. The power connector device of claim 10, wherein the coupling criterion comprises a contact area between the male and the female components that satisfies a predetermined threshold.

13. The power connector device of claim 1, wherein one alignment pin of the two or more alignment pins of the male component is larger than another alignment pin of the two or more alignment pins of the male component to ensure that the male component is oriented on the first PCB correctly.

14. The power connector device of claim 1, wherein one alignment pin of the two or more alignment pins of the female component is larger than another alignment pin of the two or more alignment pins of the female component to ensure that the female component is oriented on the second PCB correctly.

15. The power connector device of claim 1, wherein the female component comprises two sockets with threaded interior.
